(19) United States
(12) Patent Application Publication
(10) Pub. No.: US 2026/0299702 A1
(43) Pub. Date: Oct. 1, 2026

(54) INFORMATION PROCESSING APPARATUS AND INFORMATION PROCESSING METHOD

(71) Applicant: SONY GROUP CORPORATION, TOKYO (JP)

(72) Inventors: TAKESHI OGITA, TOKYO (JP); TOMOYA OUCHI, TOKYO (JP); RYOGA YUZAWA, TOKYO (JP)

(21) Appl. No.: 19/479,088

(22) PCT Filed: Apr. 23, 2024
(86) PCT No.: PCT/JP2024/015843

§ 371 Date: Oct. 27, 2025

(30) Foreign Application Priority Data
May 8, 2023 (JP) 2023-076861

(51) Int. Cl. G06F 3/01; G06F 3/04817; G06F 3/16; H04N 23/611; H04R 5/033

(52) U.S. Cl. CPC G06F 3/017; G06F 3/04817; G06F 3/16; H04N 23/611; H04R 5/033

(57) ABSTRACT

An information processing apparatus includes a control unit that controls at least an operation of an imaging apparatus on the basis of gesture information indicating a gesture detected by a head-mounted device mounted on the head of a user and imaging apparatus state information indicating a state of the imaging apparatus.

### TECHNICAL FIELD

The present technology relates to, for example, an information processing apparatus and an information processing method in which an operation based on a gesture with respect to a head-mounted device is controlled.

### BACKGROUND ART

Conventionally, there has been proposed a device that detects a physical quantity depending on movement of the neck by a first earphone and a second earphone, respectively, identifies the movement of the neck on the basis of the physical quantity detected by each of the earphones, and controls the device in accordance with the identified movement of the neck (for example, Patent Document 1).

### CITATION LIST

### Patent Document

Patent Document 1: Japanese Patent Application Laid-open Publication No. 2016-21605

### SUMMARY OF THE INVENTION

### Problems to be Solved by the Invention

Incidentally, in a case where a gesture operation is performed on an imaging apparatus by the movement of the head, there is a possibility that the imaging apparatus is operated by a movement not intended by a user. For example, in a case where the head is also moved along with the movement of the imaging apparatus at the time when the imaging apparatus is moved in a predetermined direction, there is a possibility that control on the operation due to the movement of the head is performed even though the user has simply moved the head in accordance with the movement of the imaging apparatus.

The present technology has been made in view of the problems described above, and an object thereof is to accurately control an operation on the basis of a state of the head of a user.

### Solutions to Problems

An information processing apparatus according to the present technology includes a control unit that controls at least an operation of an imaging apparatus on the basis of gesture information indicating a gesture detected by a head-mounted device mounted on the head of a user and imaging apparatus state information indicating a state of the imaging apparatus.

### BRIEF DESCRIPTION OF DRAWINGS

FIG. 1 is a diagram illustrating a configuration of an information processing system according to the embodiment.

FIG. 2 is a diagram illustrating an external appearance of an imaging apparatus.

FIG. 3 is a diagram illustrating an internal configuration of the imaging apparatus.

FIG. 4 is a diagram illustrating an internal configuration of a headphone.

FIG. 5 is a diagram illustrating functional configurations of a camera control unit and a headphone control unit.

FIG. 6 is a diagram illustrating a state in which a user is capturing an image with the imaging apparatus while wearing the headphone.

FIG. 7 is a diagram illustrating a flowchart of control processing in a first embodiment.

FIG. 8 is a diagram illustrating an example of operations of the imaging apparatus and the headphone based on a headphone gesture.

FIG. 9 is a diagram illustrating an example of notification of operations based on a gesture.

FIG. 10 is a diagram illustrating an example of a camera GUI.

FIG. 11 is a diagram illustrating an example of a headphone GUI.

FIG. 12 is a diagram illustrating a flowchart of control processing in Modification 1 of the first embodiment.

FIG. 13 is a diagram illustrating a flowchart of control processing in Modification 2 of the first embodiment.

FIG. 14 is a diagram illustrating a flowchart of control processing in a second embodiment.

FIG. 15 is a diagram illustrating an example of the operations of the imaging apparatus with respect to a combination of a headphone gesture and a camera state.

FIG. 16 is a diagram for explaining the orientation of the imaging apparatus in a case where a user captures an image while lying on one's side.

FIG. 17 is a diagram illustrating a flowchart of control processing in the second embodiment.

FIG. 18 is a diagram illustrating an example of the orientations of a screen with respect to a headphone gesture and a camera state.

FIG. 19 is a diagram illustrating a state in which a user is imaging oneself by the imaging apparatus.

FIG. 20 is a diagram illustrating a state in which an image is being captured by the imaging apparatus by using a tripod.

FIG. 21 is a diagram illustrating a state in which a mobile terminal apparatus is wirelessly connected to the imaging apparatus.

FIG. 22 is a diagram illustrating a flowchart of control processing in a fourth embodiment.

FIG. 23 is a diagram illustrating a flowchart of control processing in the fourth embodiment.

FIG. 24 is a diagram illustrating an example of operations of the imaging apparatus, the headphone, and the mobile terminal based on a headphone gesture.

FIG. 25 is a diagram illustrating an example of notification made with respect to a headphone gesture.

### MODE FOR CARRYING OUT THE INVENTION

Hereinafter, embodiments will be described in the following order with reference to the accompanying drawings.
<1. Configuration of information processing system>
<2. First embodiment>
<3. Second embodiment>
<4. Third embodiment>
<5. Fourth embodiment>
<6. Modifications>
<7. Summary>
<8. Present technology>

### 1. Configuration of Information Processing System

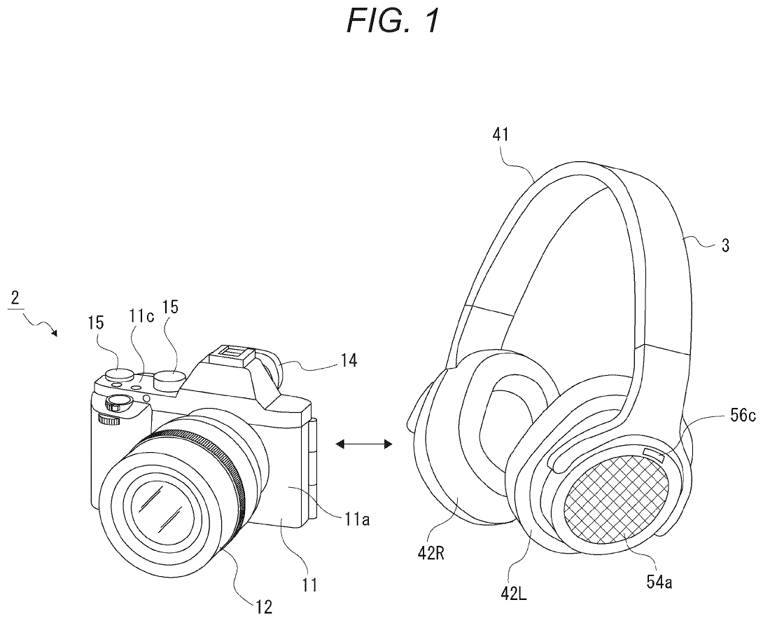

FIG. 1 is a diagram illustrating a configuration of an information processing system 1 according to the present embodiment. As illustrated in FIG. 1, an information processing system 1 includes an imaging apparatus 2 which is an embodiment of an information processing apparatus, and a headphone 3 which is an embodiment of a head-mounted device.

The imaging apparatus 2 and the headphone 3 are wirelessly connected to each other while conforming to, for example, the Bluetooth (registered trademark) standard, and can wirelessly communicate with each other. Note that the imaging apparatus 2 and the headphone 3 may be connected by wire or may be wirelessly connected to each other while conforming to another standard.

The imaging apparatus 2 is a camera that images a subject in accordance with a user operation to generate a still image and a moving image. However, the imaging apparatus 2 may be able to generate only one of a still image and a moving image.

The headphone 3 is worn on the head of the user. The headphone 3 outputs sound input from the imaging apparatus 2 via, for example, wireless communication. Furthermore, the headphone 3 may be wirelessly connected to a mobile terminal apparatus such as a smartphone and output sound (for example, music) input from the mobile terminal apparatus. Moreover, the headphone 3 may output sound stored in a not-illustrated storage unit.

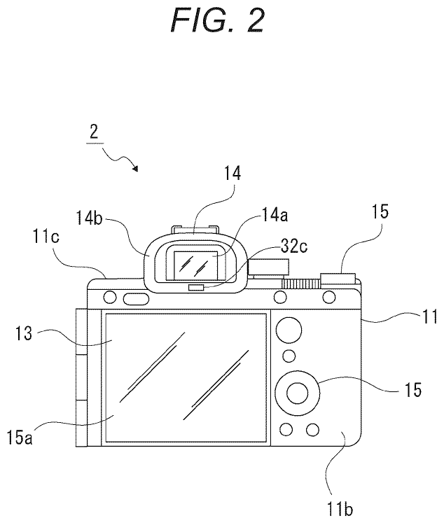

FIG. 2 is a diagram illustrating an external appearance of the imaging apparatus 2. Note that, in the following description, a subject side is referred to as the front, and an imaging operator (user) side as the rear.

As illustrated in FIGS. 1 and 2, the imaging apparatus 2 includes a camera housing 11 with necessary parts disposed inside and outside thereof, and a lens barrel 12 detachable from the camera housing 11 and attached to a front surface part 11a.

Note that an example will be described in which the lens barrel 12 is detachable as a so-called interchangeable lens in the imaging apparatus 2, but the imaging apparatus 2 may have a configuration in which the lens barrel 12 cannot be detached from the camera housing 11.

A display unit 13 is disposed on a rear surface part 11b of the camera housing 11. The display unit 13 displays a live view image, a recorded image, and the like.

The display unit 13 includes, for example, a display device such as a liquid crystal display (LCD) or an organic electro-luminescence (EL) display.

The display unit 13 is made pivotable relative to the camera housing 11. For example, the left end portion of the display unit 13 is set as a rotation shaft, and the right end portion of the display unit 13 is made rotatable to be moved rearward. Note that the right end portion, the upper end portion, or the lower end portion of the display unit 13 may be used as a rotation shaft. Moreover, the display unit 13 may be made rotatable in directions around a plurality of axes.

The camera housing 11 has an upper surface part 11c on which an electric viewfinder (EVF) 14 is disposed. The EVF 14 includes an EVF monitor 14a and a frame-shaped enclosure part 14b projecting backward so as to surround the circumference of the EVF monitor 14a.

The EVF monitor 14a is constituted by using an LCD, an organic EL display, or the like. Note that, instead of the EVF monitor 14a, an optical view finder (OVF) may be provided.

On the rear surface part 11b and the upper surface part 11c, various types of operation units 15 are provided. Examples thereof include a shutter button (a release button), a reproduction menu activation button, a determination button, a cross key, a cancel button, a zoom key, a slide key, and the like.

These operation units 15 include those of various forms such as a button, a dial, a composite operation element that can be pressed and rotated, and the like. Furthermore, the operation unit 15 also includes a touch panel 15a provided on the front surface of the display unit 13.

The operation units 15 of the various forms enable, for example, a shutter operation, a menu operation, a reproduction operation, a mode selection operation, a focus operation, a zoom operation, and selection operation of parameters such as a shutter speed and an F-number.

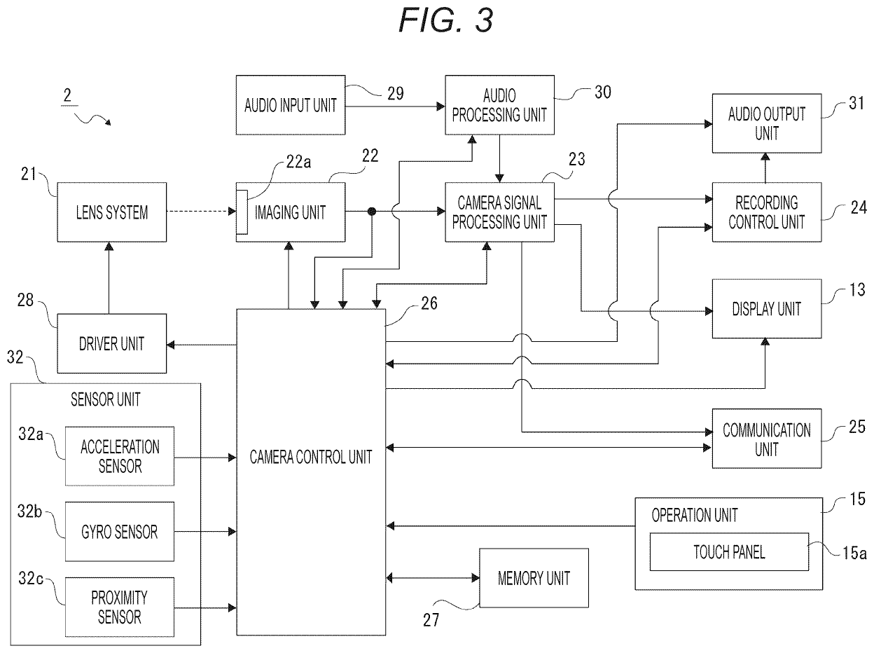

FIG. 3 is a diagram illustrating an internal configuration of the imaging apparatus 2. As illustrated in FIG. 3, in addition to the display unit 13 and the operation units 15, the imaging apparatus 2 includes a lens system 21, an imaging unit 22, a camera signal processing unit 23, a recording control unit 24, a communication unit 25, a camera control unit 26, a memory unit 27, a driver unit 28, an audio input unit 29, an audio processing unit 30, an audio output unit 31, and a sensor unit 32.

The lens system 21 includes lenses such as a zoom lens, and a focus lens, an aperture mechanism, and the like. Light (incident light) from a subject is guided by this lens system 21 and focused on the imaging unit 22.

The imaging unit 22 includes, for example, an image sensor 22a (imaging element) of a complementary metal oxide semiconductor (CMOS) type, a charge coupled device (CCD) type, or the like.

The imaging unit 22 performs, for example, correlated double sampling (CDS) processing, automatic gain control (AGC) processing, and the like on an electrical signal obtained by photoelectrically converting the light received by the image sensor 22a, and further performs analog/digital (A/D) conversion processing on the electrical signal. Then, the imaging unit 22 outputs a captured image signal as digital data to the camera signal processing unit 23 and the camera control unit 26 in the subsequent stage.

The camera signal processing unit 23 is configured as, for example, an image processing processor using a digital signal processor (DSP) or the like. The camera signal processing unit 23 performs various types of signal processing on the captured image signal from the imaging unit 22. The camera signal processing unit 23 performs, for example, preprocessing, demosaicing processing, YC generation processing, resolution conversion processing, file formation processing, and the like.

In the preprocessing, clamping processing of clamping black levels of R, G, and B to a predetermined level, correction processing among color channels of R, G, and B, and the like is performed on the captured image signal from the imaging unit 22.

In the demosaicing processing, color separation processing is performed so that image data for each pixel has all of R, G, and B color components. For example, in a case of an imaging element using a color filter of Bayer array, demosaicing processing is performed as the color separation processing.

In the YC generation processing, a luminance (Y) signal and a color (C) signal are generated (separated) from the image data of R, G, and B.

In the resolution conversion processing, resolution conversion processing is executed on the image data subjected to various types of signal processing.

In the file formation processing, image data on which the various types of processing described above are performed is subjected to, for example, compression encoding for recording or communication, formatting, and generation or addition of metadata to generate a file for recording or communication.

For example, an image file in a format such as a joint photographic experts group (JPEG), a tagged image file format (TIFF), or a graphics interchange format (GIF) is generated as a still image file. Furthermore, it is conceivable that an image file is generated in an MP4 format used for recording video and audio conforming to MPEG-4.

Note that it is also conceivable to generate an image file as raw image data.

The camera signal processing unit 23 generates the metadata as metadata including information of processing parameters in the camera signal processing unit 23, various control parameters acquired from the camera control unit 26, information indicating a motion state of the lens system 21 and the imaging unit 22, mode setting information, and imaging environment information (such as date and time, and place).

The recording control unit 24 performs, for example, recording and reproduction on a recording medium by a nonvolatile memory. The recording control unit 24 performs, for example, processing for recording image files such as moving image data and still image data, thumbnail images, and the like on a recording medium.

Various actual forms of the recording control unit 24 are conceivable. For example, the recording control unit 24 may include a flash memory built in the imaging apparatus 2 and a write/read circuit thereof. Furthermore, the recording control unit 24 may be in the form of a card recording/reproducing unit that performs recording/reproducing access to a recording medium, for example, a memory card (such as a portable flash memory) removably fitted into the imaging apparatus 2. Furthermore, the recording control unit 24 may be implemented as a hard disk drive (HDD) or the like as a form built in the imaging apparatus 2.

The display unit 13 displays various types of information on a display screen on the basis of an instruction from the camera control unit 26.

For example, the display unit 13 displays reproduced images of image data read from the recording medium in the recording control unit 24.

Furthermore, there is a case where image data of a captured image whose resolution has been converted for display by the camera signal processing unit 23 is supplied to the display unit 13, and the display unit 13 performs display on the basis of the image data of the captured image in accordance with an instruction from the camera control unit 26. With this arrangement, a so-called through image (subject monitoring image) is displayed, the through image being a captured image during composition confirmation or during moving image recording. Note that the through image is also displayed on the EVF 14.

Furthermore, the display unit 13 displays various operation menus, icons, messages, and the like, that is, a graphical user interface (GUI), on the screen on the basis of instructions from the camera control unit 26.

The communication unit 25 performs, for example, wireless communication conforming to Bluetooth (registered trademark) with the headphone 3.

Furthermore, the communication unit 25 may communicate with other devices in a wired or wireless manner. The communication unit 25 performs, for example, transmission and output of captured image data (still image file or moving image file) to the external display device, recording device, reproduction device, or the like.

The camera control unit 26 includes a microcomputer (arithmetic processing unit) equipped with a central processing unit (CPU).

The memory unit 27 stores information and the like used by the camera control unit 26 for processing. The memory unit 27 comprehensively represents, for example, a read-only memory (ROM), a random-access memory (RAM), a flash memory, and the like.

The memory unit 27 may be a memory area built in a microcomputer chip serving as the camera control unit 26 or may be configured by using a separate memory chip.

The camera control unit 26 controls the entire imaging apparatus 2 by executing a program stored in the ROM, the flash memory, or the like of the memory unit 27.

For example, the camera control unit 26 controls the motion of each necessary unit with respect to control of the shutter speed of the imaging unit 22, instructions of various types of signal processing in the camera signal processing unit 23, imaging motion and recording motion corresponding to the user operation, reproduction motion of the recorded image file, motion of the lens system 21 such as zooming, focusing, and aperture adjustment in the lens barrel 12, user interface motion, processing of the audio processing unit 30, and the like.

The RAM in the memory unit 27 is used to temporarily store data, programs, and the like as a work area during various types of data processing performed by the CPU of the camera control unit 26.

The ROM and the flash memory (non-volatile memory) in the memory unit 27 are used for storing an operating system (OS) for the CPU to control each unit, content files such as image files, application programs for various types of motion, firmware, various types of setting information, and the like.

The various types of setting information include exposure setting as setting information regarding the imaging motion, shutter speed setting, mode setting, white balance setting as setting information regarding image processing, color setting, setting regarding an image effect, setting regarding processing of the audio processing unit 30 (for example, setting of sound volume, sound quality, and parameters regarding other types of processing), custom key setting and display setting as setting information regarding operativity, and the like.

The driver unit 28 is provided, for example, with a motor driver for a zoom lens drive motor, a motor driver for a focus lens drive motor, a motor driver for a diaphragm mechanism motor, and the like.

In these motor drivers, a drive current is applied to the corresponding driver in response to an instruction from the camera control unit 26 to perform moving of the focus lens and zoom lens, opening and closing of aperture blades of the aperture mechanism, and the like.

The sensor unit 32 comprehensively indicates various types of sensors mounted on the imaging apparatus 2.

As the sensor unit 32, for example, an acceleration sensor 32a, a gyro sensor 32b, and a proximity sensor 32c are provided.

The acceleration sensor 32a detects accelerations in three axial directions, which are a roll axis (axis in the front-rear direction), a pitch axis (axis in the left-right direction), and a yaw axis (axis in the up-down direction), of the imaging apparatus 2.

The gyro sensor 32b detects angular velocities around three axes, which are the roll axis, the pitch axis, and the yaw axis, of the imaging apparatus 2.

The proximity sensor 32c is, for example, an infrared (IR) sensor, and is provided in the enclosure part 14b of the EVF 14 as illustrated in FIG. 2. The proximity sensor 32c detects that the imaging operator (user) has approached the EVF 14. That is, the proximity sensor 32c detects whether or not the imaging operator is looking into the EVF 14.

The audio input unit 29 includes, for example, a microphone, a microphone amplifier, and the like, collects ambient audio, and outputs the collected ambient sound as an audio signal.

The audio processing unit 30 performs processing of converting the audio signal obtained by the audio input unit 29 into a digital audio signal, AGC processing, sound quality processing, noise reduction processing, and the like. The audio data subjected to these pieces of processing is output to the camera signal processing unit 23 and the camera control unit 26.

For example, the audio data is processed as audio data accompanying a moving image in the camera control unit 26 at the time of capturing the moving image.

The audio output unit 31 includes an audio signal processing circuit, a power amplifier, a speaker, and the like, and reproduces an audio file recorded on the recording medium by the recording control unit 24. At the time of reproducing a moving image, audio accompanying the moving image is reproduced by the audio output unit 31.

As illustrated in FIG. 1, the headphone 3 includes a headband 41 and a pair of housing units 42R and 42L. The headband 41 is formed in a curved shape along the head of a user, and supports the entire headphone 3 by being in contact with the top of the head of the user in the worn state.

The housing units 42R and 42L are attached to both ends of the headband 41, respectively. The housing unit 42R is disposed at a position facing the right ear of the user at the time when the headphone 3 is worn on the head of the user. The housing unit 42L is disposed at a position facing the left ear of the user at the time when the headphone 3 is worn on the head of the user.

Note that, hereinafter, the housing unit 42R and the housing unit 42L will be simply referred to as the housing unit 42 in a case where the housing unit 42R and the housing unit 42L are not necessarily distinguished from each other.

Furthermore, a touch panel 54a and a proximity sensor 56c are each provided on a surface of the housing unit 42, which is the outer housing portion of the headphone 3, the surface being provided on the side opposite to the user, that is, on a housing surface facing outward.

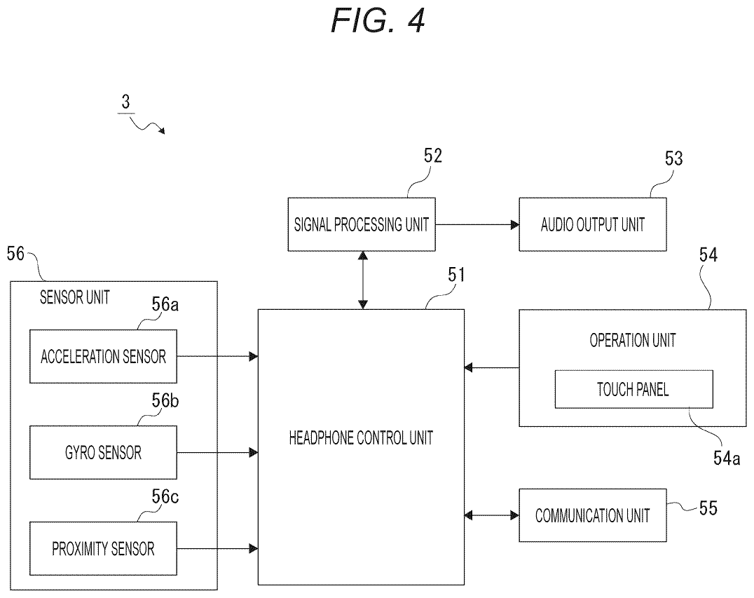

FIG. 4 is a diagram illustrating an internal configuration of the headphone 3. As illustrated in FIG. 4, the headphone 3 includes a headphone control unit 51, a signal processing unit 52, an audio output unit 53, an operation unit 54, a communication unit 55, and a sensor unit 56.

The headphone control unit 51 includes a microcomputer (arithmetic processing unit) equipped with a CPU, a RAM, and a ROM.

The headphone control unit 51 executes a program stored in the ROM, a flash memory, or the like to integrally control the entire headphone 3.

For example, the headphone control unit 51 controls the motion of each necessary unit for sound reproduction corresponding to the user operation, processing of the audio processing unit 30, and the like.

The signal processing unit 52 includes an audio signal processing circuit and a power amplifier, and for example, converts a digital audio signal input via the communication unit 55 into an analog audio signal, amplifies the analog audio signal, and outputs the amplified analog audio signal to the audio output unit 53.

The audio output unit 53 includes, for example, a speaker, and is provided in each of the housing unit 42R and the housing unit 42L. The audio output unit 53 outputs (reproduces) sound based on the analog audio signal input from the signal processing unit 52.

The operation unit 54 includes the touch panel 54a provided on the housing surface of the housing unit 42. The operation unit 54 enables, for example, a reproduction operation, a volume up operation, a volume down operation, and the like.

The communication unit 55 performs, for example, wireless communication conforming to Bluetooth (registered trademark) with the imaging apparatus 2.

Furthermore, the communication unit 55 may communicate with other devices in a wired or wireless manner. The communication unit 55 receives a digital audio signal from, for example, an external mobile terminal apparatus, a personal computer, or the like.

The sensor unit 56 comprehensively indicates various types of sensors mounted on the headphone 3.

As the sensor unit 56, for example, an acceleration sensor 56a, a gyro sensor 56b, and the proximity sensor 56c are provided.

The acceleration sensor 56a detects acceleration in three axial directions, which are the roll axis, the pitch axis, and the yaw axis, of the headphone 3.

The gyro sensor 56b detects angular velocities around three axes, which are the roll axis, the pitch axis, and the yaw axis, of the headphone 3.

The proximity sensor 56c is, for example, an infrared (IR) sensor, and is provided on the housing surface of the housing unit 42 as illustrated in FIG. 1. The proximity sensor 56c detects that the hand of the user has approached the housing unit 42. Therefore, the proximity sensor 56c also functions as the operation unit 54 that receives a gesture input by the hand of the user.

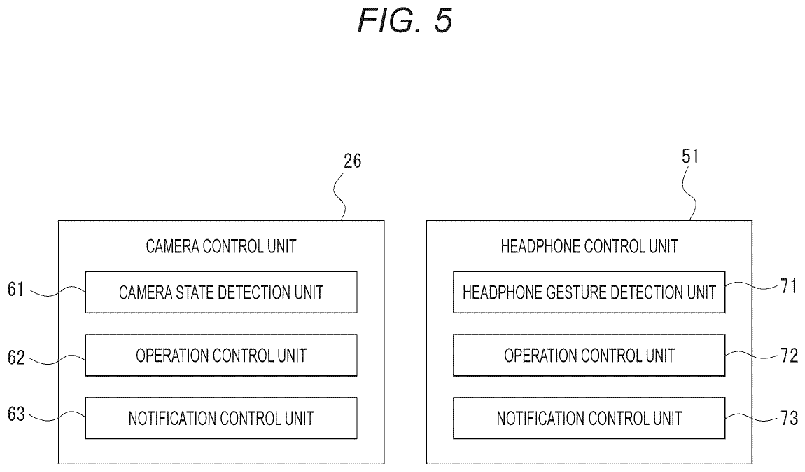

FIG. 5 is a diagram illustrating functional configurations of the camera control unit 26 and the headphone control unit 51. As illustrated in FIG. 5, the camera control unit 26 includes a camera state detection unit 61, an operation control unit 62, and a notification control unit 63.

The camera state detection unit 61 acquires the acceleration detected by the acceleration sensor 32a and the angular velocity detected by the gyro sensor 32b. Then, the camera state detection unit 61 detects the state (movement and posture) of the imaging apparatus 2 on the basis of the acquired acceleration and angular velocity. Note that, hereinafter, the state of the imaging apparatus 2 is referred to as a camera state.

In this manner, the camera state detection unit 61 acquires information indicating the camera state (hereinafter, referred to as camera state information).

The operation control unit 62 controls the operation of at least the imaging apparatus 2, more specifically, the imaging apparatus 2 and the headphone 3 on the basis of headphone gesture information and camera state information described later.

Note that, in a case where the imaging apparatus 2 is operated, the operation control unit 62 performs the operation based on the headphone gesture information and the camera state information.

Furthermore, in a case where the headphone 3 is operated, the operation control unit 62 instructs the headphone 3 to perform the operation based on the headphone gesture information and the camera state information. In the headphone 3 that has received the instruction, the operation based on the headphone gesture information and the camera state information is performed by the operation control unit 72 described later.

The notification control unit 63 notifies the user of the headphone gesture information and the operation based on the headphone gesture information and the camera state information. Furthermore, the notification control unit 63 transmits information indicating the performed operation to the headphone 3 via the communication unit 25.

The headphone control unit 51 functions as a headphone gesture detection unit 71, an operation control unit 72, and a notification control unit 73.

The headphone gesture detection unit 71 detects the state (movement and posture) of the headphone 3 on the basis of the acceleration detected by the acceleration sensor 56a and the angular velocity detected by the gyro sensor 56b. Here, because the headphone 3 is worn on the head of the user, the headphone gesture detection unit 71 detects the movement and posture of the head of the user by detecting the movement and posture of the headphone 3.

Then, the headphone gesture detection unit 71 detects a predetermined specific movement or posture as the gesture of the headphone 3 on the basis of the detected state of the headphone 3. Note that, hereinafter, the gesture detected by the headphone 3 is referred to as a headphone gesture.

Upon detecting the headphone gesture, the headphone gesture detection unit 71 transmits information (hereinafter, referred to as headphone gesture information) indicating the detected headphone gesture to the imaging apparatus 2 via the communication unit 55. With this arrangement, the imaging apparatus 2 acquires the headphone gesture information transmitted from the headphone 3 via the communication unit 25.

Note that the headphone gesture detection unit 71 may transmit the acceleration detected by the acceleration sensor 56a and the angular velocity detected by the gyro sensor 56b to the imaging apparatus 2 as the headphone gesture information. In this case, the camera control unit 26 is only required to function as the headphone gesture detection unit 71 to detect the headphone gesture on the basis of the transmitted acceleration and angular velocity.

In the case of receiving the instruction from the imaging apparatus 2 to perform the operation based on the headphone gesture information and the camera state information, the operation control unit 72 performs control corresponding to the instruction.

Upon receiving information indicating the operation performed on the basis of the headphone gesture information and the camera state information, the notification control unit 73 notifies the user of the operation indicated in the information.

Hereinafter, processing performed by each functional unit of the camera control unit 26 and the headphone control unit 51 will be described separately from the first embodiment to the fourth embodiment. Note that, in the first embodiment to the fourth embodiment, some of the functional units described above do not perform processing in some cases.

### 2. First Embodiment

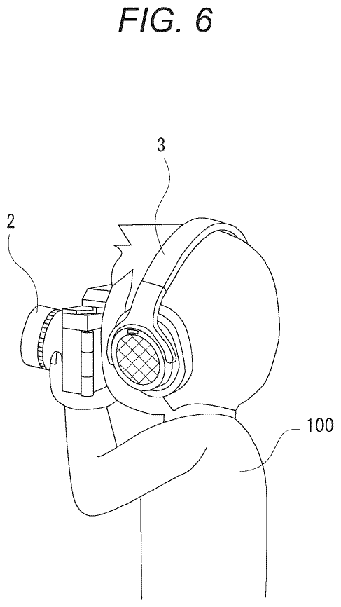

FIG. 6 is a diagram illustrating a state in which a user 100 is capturing an image with the imaging apparatus 2 while wearing the headphone 3. As illustrated in FIG. 6, it is conceivable that the user 100 captures an image of a subject with the imaging apparatus 2 in the state of wearing the headphone 3 on the head.

Then, it is assumed that the user 100 images the subject with imaging apparatus 2 while looking into the EVF 14. In that case, the user 100 will be moving one's head together at the time when moving the imaging apparatus 2 to an optional position. That is, the movement of the imaging apparatus 2 and the movement of the headphone 3 almost coincide with each other.

At this time, if the operation is controlled on the basis of the movement of the headphone 3, that is, the headphone gesture information, there is a possibility that the operation not intended by the user 100 is performed even in a case where the user 100 has simply moved the head together with the imaging apparatus 2.

Therefore, in the first embodiment, in a case where the headphone gesture matches the camera state, the operation control unit 62 does not perform (cancels) the operation based on the headphone gesture information.

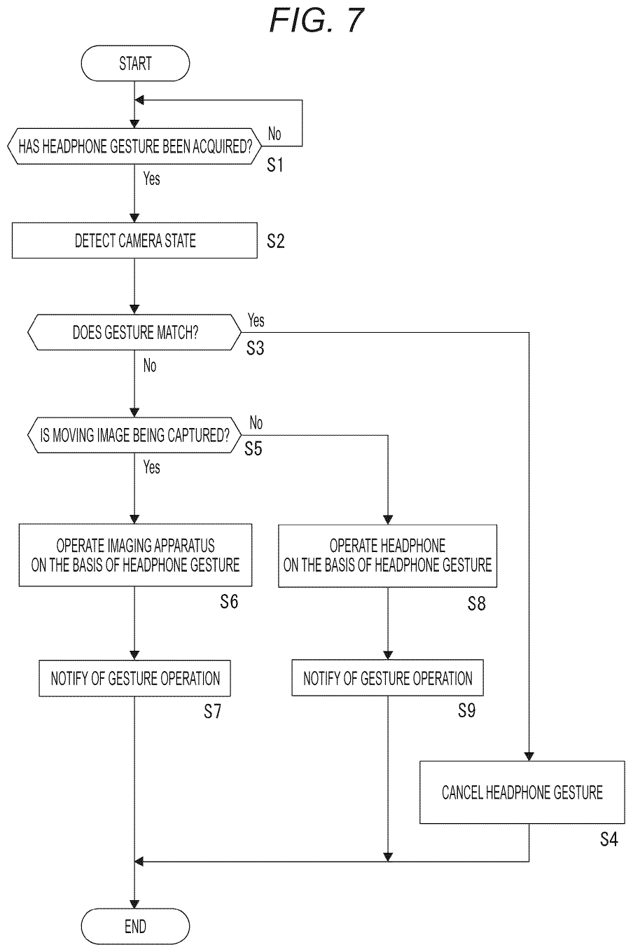

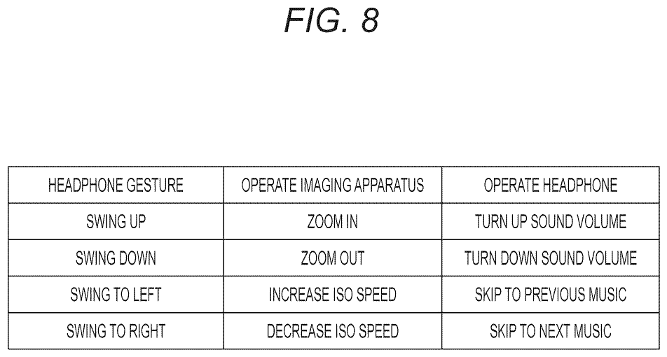

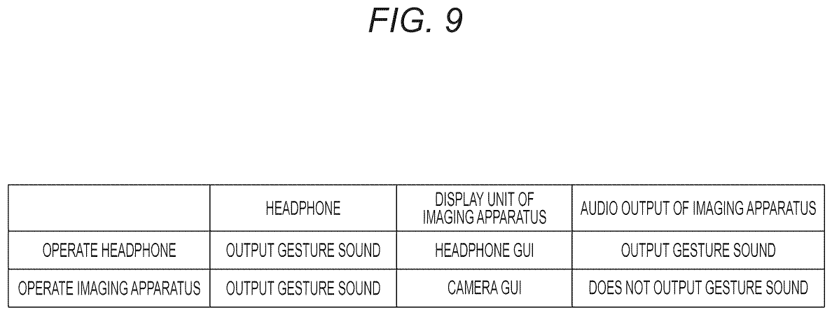

FIG. 7 is a diagram illustrating a flowchart of control processing in the first embodiment. FIG. 8 is a diagram illustrating an example of operations of the imaging apparatus 2 and the headphone 3 based on the headphone gesture information. FIG. 9 is a diagram illustrating an example of notification of operations based on the headphone gesture information.

As illustrated in FIG. 7, when the control processing is started, in step S1, the camera control unit 26 determines whether the headphone gesture information has been acquired from the headphone 3.

Here, in the headphone 3, the headphone gesture detection unit 71 acquires the acceleration detected by the acceleration sensor 56a and the angular velocity detected by the gyro sensor 56b as needed, and detects the headphone gesture on the basis of the acquired acceleration and angular velocity. For example, the headphone gesture detection unit 71 detects the headphone gestures of “swing up”, “swing down”, “swing to the right”, and “swing to the left”.

Then, the headphone gesture detection unit 71 transmits the headphone gesture information indicating the detected headphone gesture to the imaging apparatus 2.

Upon receiving the headphone gesture information from the headphone 3, (Yes in step S1), in step S2, the camera state detection unit 61 detects the camera state on the basis of the acceleration detected by the acceleration sensor 32a and the angular velocity detected by the gyro sensor 32b. Here, the camera state detection unit 61 detects the state change in, for example, “upward”, “downward”, “rightward”, or “leftward”. However, because the state of the imaging apparatus 2 does not change in some cases, the camera state detection unit 61 does not necessarily detect these camera states.

In step S3, the operation control unit 62 determines whether the camera state matches the headphone gesture. Here, the operation control unit 62 determines whether the imaging apparatus 2 and the headphone 3 are moving in the same direction, that is, whether the user 100 is moving while looking into the EVF 14 of the imaging apparatus 2. For example, in a case where the headphone gesture is “swing up” and the camera state is the state change to “upward”, the operation control unit 62 determines that the camera state matches the headphone gesture. Note that “matching” includes not only a case where the headphone gesture completely matches the camera state but also a case where the headphone gesture is determined to match the camera state while including an error within a predetermined range.

Then, in a case where the camera state matches the headphone gesture (Yes in step S3), that is, in a case where the user 100 is moving while looking into the EVF 14 of the imaging apparatus 2, in step S4, the operation control unit 62 cancels the operation based on the headphone gesture information.

In this case, the operation control unit 62 determines that the user 100 is not making a gesture but the user 100 is only moving while looking into the EVF 14 of the imaging apparatus 2, and thus, performs the control not to perform the operation based on the headphone gesture information.

On the other hand, in a case where the camera state does not match the headphone gesture (No in step S3), that is, in a case where the head of user 100 and the imaging apparatus 2 are moving separately, it is determined that the user 100 is making a gesture.

Then, in step S5, the operation control unit 62 determines whether the imaging apparatus 2 is capturing a moving image. Here, it is assumed that, while the moving image is being captured, the imaging apparatus 2 is operated by the headphone gesture so that so-called camera shake does not occur in the imaging apparatus 2. Furthermore, it is assumed that, at the time where the moving image is not being captured, the headphone 3 is simply operated by the headphone gesture.

In a case where the moving image is being captured (Yes in step S5), in step S6, the operation control unit 62 controls the operation of the imaging apparatus 2 on the basis of the headphone gesture information.

Here, as illustrated in FIG. 8, in a case where the headphone gesture is “swing up”, the operation control unit 62 controls the imaging apparatus 2 to zoom in. Furthermore, in a case where the headphone gesture is “swing down”, the operation control unit 62 controls the imaging apparatus 2 to zoom out. Furthermore, in a case where the headphone gesture is “swing to the left”, the operation control unit 62 controls the imaging apparatus 2 to increase the ISO speed. Furthermore, in a case where the headphone gesture is “swing to the right”, the operation control unit 62 controls the imaging apparatus 2 to decrease the ISO speed.

In step S7, the notification control unit 63 notifies of the operation of the imaging apparatus 2 based on the headphone gesture information performed in step S6.

As illustrated in FIG. 9, in a case where the operation of the imaging apparatus 2 is controlled on the basis of the headphone gesture information, the notification control unit 63 instructs the headphone 3 to output, from the audio output unit 53, a gesture sound (notification sound) notifying that the imaging apparatus 2 has been operated on the basis of the headphone gesture information. With this arrangement, in the headphone 3, the notification control unit 73 causes the audio output unit 53 to output a gesture sound notifying that the operation of the imaging apparatus 2 has been controlled on the basis of the headphone gesture information.

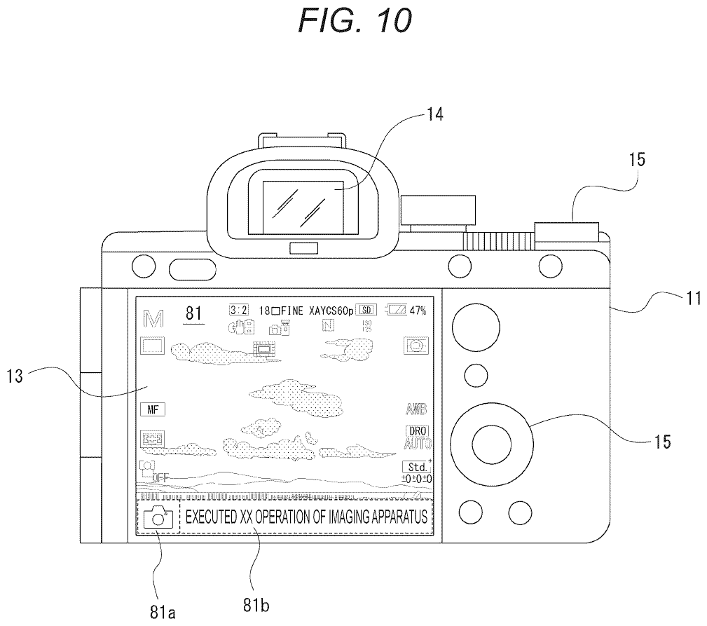

Furthermore, in a case where the operation of the imaging apparatus 2 is controlled on the basis of the headphone gesture information, the notification control unit 63 causes the display unit 13 to display a camera GUI 81 as illustrated in FIG. 10 for notifying that the operation of the imaging apparatus 2 is controlled on the basis of the headphone gesture information.

FIG. 10 is a diagram illustrating an example of the camera GUI 81. As illustrated in FIG. 10, in the camera GUI 81, a camera icon 81a and an operation control comment 81b indicating that the operation of the imaging apparatus 2 has been controlled on the basis of the headphone gesture are displayed at the lower part.

The camera icon 81a is an icon imitating the imaging apparatus 2 in order to make it easy to understand that the operation control target is imaging apparatus 2, and is highlighted as compared with a headphone icon 82a described later. For example, the camera icon 81a is displayed as a larger icon than the headphone icon 82a.

Furthermore, the operation control comment 81b is highlighted as compared with, for example, an operation control comment 82b described later. For example, the operation control comment 81b is displayed with larger characters and a different color (conspicuous color) than those of the operation control comment 82b.

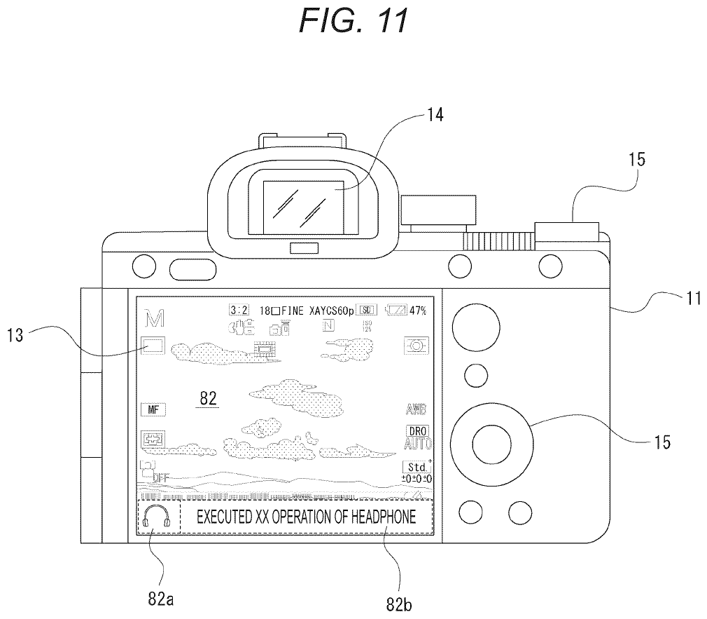

As described above, in a case where the operation of the imaging apparatus 2 is controlled on the basis of the headphone gesture information, the display mode is emphasized as compared with a headphone GUI 82 (see FIG. 11), so that the user 100 is notified in an easy-to-understand manner.

However, in a case where the operation of the imaging apparatus 2 is controlled on the basis of the headphone gesture information, the notification control unit 63 causes the audio output unit 31 not to output the gesture sound notifying that the operation of the imaging apparatus 2 has been controlled on the basis of the headphone gesture information. This is to prevent the gesture sound from being collected by the audio input unit 29 when the gesture sound is output during capturing of the moving image.

On the other hand, in a case where the moving image is not being captured (No in step S5), in step S8, the operation control unit 62 controls the operation of the headphone 3 on the basis of the headphone gesture information.

Here, as illustrated in FIG. 8, in a case where the headphone gesture is “swing up”, the operation control unit 62 gives instruction to the headphone 3 to turn the sound volume up in the headphone 3. In the headphone 3, the operation control unit 72 performs control to turn up the sound volume.

Furthermore, in a case where the headphone gesture is “swing down”, the operation control unit 62 gives instruction to turn the sound volume down in the headphone 3. In the headphone 3, the operation control unit 72 performs control to turn down the sound volume.

Furthermore, in a case where the headphone gesture is “swing to the left”, the operation control unit 62 gives instruction to skip to a previous piece of music in the headphone 3. In the headphone 3, the operation control unit 72 performs control to skip to the previous piece of music.

Furthermore, in a case where the headphone gesture is “swing to the right”, the operation control unit 62 gives instruction to skip to a next piece of music in the headphone 3. In the headphone 3, the operation control unit 72 performs control to skip to the next piece of music.

In step S9, the notification control unit 63 notifies of the operation of the headphone 3 based on the headphone gesture information performed in step S8.

As illustrated in FIG. 9, in a case where the operation of the headphone 3 is controlled on the basis of the headphone gesture information, the notification control unit 63 instructs the headphone 3 to output, from the audio output unit 53, a gesture sound (notification sound) notifying that the headphone 3 has been operated on the basis of the headphone gesture information. With this arrangement, in the headphone 3, the notification control unit 73 causes the audio output unit 53 to output a gesture sound notifying that the headphone 3 has been operated on the basis of the headphone gesture information.

Furthermore, in a case where the operation of the headphone 3 is controlled on the basis of the headphone gesture information, the notification control unit 63 causes the display unit 13 to display the headphone GUI 82 notifying that the headphone 3 has been operated on the basis of the headphone gesture information as illustrated in FIG. 11.

FIG. 11 is a diagram illustrating an example of the headphone GUI 82. As illustrated in FIG. 11, in the headphone GUI 82, the headphone icon 82a and the operation control comment 82b indicating that the headphone 3 has been operated on the basis of the headphone gesture information are displayed at the lower part.

The headphone icon 82a is a small icon imitating the headphone 3 to make it easy to understand that the operation control target is the headphone 3. Furthermore, the operation control comment 82b is displayed with smaller characters and in an inconspicuous color (for example, black) as compared with the operation control comment 81b.

As described above, in the headphone GUI 82, because the operation control target is the headphone 3, notification is made on the display unit 13 of the imaging apparatus 2 so as not to disturb the imaging.

Moreover, in a case where the operation of the headphone 3 is controlled on the basis of the headphone gesture information, the notification control unit 63 outputs, from the audio output unit 31, the gesture sound notifying that the headphone 3 is operated on the basis of the headphone gesture information and the headphone 3 has been operated on the basis of the headphone gesture information. Here, because the moving image is not captured by the imaging apparatus 2, the gesture sound is not collected by the audio input unit 29. Therefore, the gesture sound is output from the imaging apparatus 2 to notify the user that the operation has been performed on the basis of the headphone gesture information.

Note that, in a case where it is determined in step S3 that the camera state information does not match the headphone gesture information, the operation based on the headphone gesture information is canceled. Therefore, here, it can be said that the operation control unit 62 determines whether or not to execute the operation on the headphone 3 based on the headphone gesture information on the basis of the camera state information.

### 2-1. Modification 1 of First Embodiment

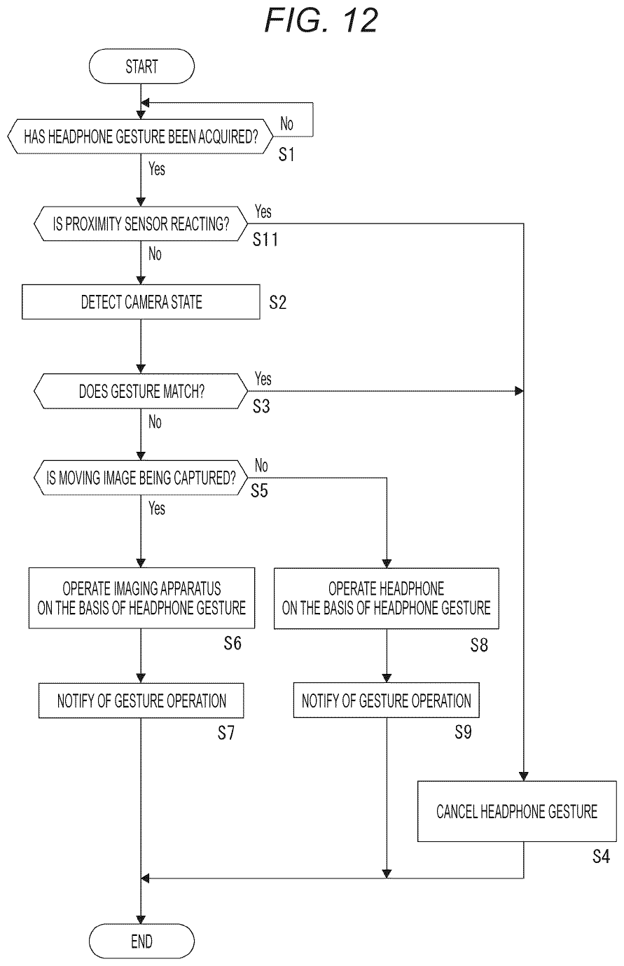

FIG. 12 is a diagram illustrating a flowchart of control processing in Modification 1 of the first embodiment. Modification 1 is different from the first embodiment in that it is determined whether or not to cancel the operation based on the gesture information on the basis of the detection result of the proximity sensor 32c.

Note that pieces of processing different from those of the first embodiment will be described here, and the same piece of processing as that of the first embodiment will be denoted by the same reference numeral, and the description thereof will be omitted.

As illustrated in FIG. 12, when the control processing is started and the information regarding the headphone gesture is acquired in step S1, in step S11, the operation control unit 62 determines whether the user is looking into the EVF 14. Here, whether the user is approaching the EVF 14 is determined based on whether or not the proximity sensor 32c is reacting.

Then, in a case where the proximity sensor 32c is reacting (Yes in step S11), that is, in a case where the user 100 is looking into the EVF 14, the operation control unit 62 determines that the user is not performing the gesture on the headphone 3 because the user 100 is looking into the EVF 14. Therefore, in a case where the proximity sensor 32c is reacting (Yes in step S11), the processing proceeds to step S4, and the operation control unit 62 cancels the gesture operation even if the headphone gesture is detected.

On the other hand, in a case where the proximity sensor 32c is not reacting (No in step S11), that is, in a case where the user 100 is not approaching the EVF 14, the operation control unit 62 determines that the user is performing the gesture on the headphone 3 because the user 100 is not looking into the EVF 14. Therefore, in a case where the proximity sensor 32c is not reacting (No in step S11), the camera control unit 26 performs steps S2 to S9 described above.

With this arrangement, because the operation based on the headphone gesture detected at the time when the user 100 is looking into the EVF 14 is not performed, the operation based on the movement or posture not intended by the user can be reduced.

### 2-2. Modification 2 of First Embodiment

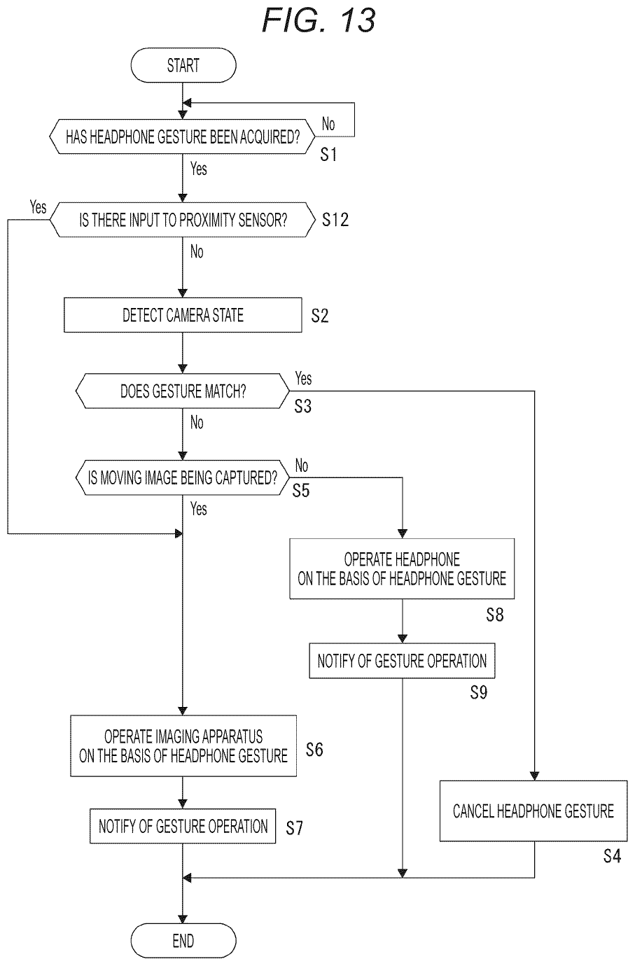

FIG. 13 is a diagram illustrating a flowchart of control processing in Modification 2 of the first embodiment. Modification 2 is different from the first embodiment in that the gesture operation is performed on the basis of the detection result of the proximity sensor 56c.

Note that pieces of processing different from those of the first embodiment will be described here, and the same piece of processing as that of the first embodiment will be denoted by the same reference numeral, and the description thereof will be omitted.

As illustrated in FIG. 13, when the control processing is started and the information regarding the headphone gesture is acquired in step S1, in step S12, the camera control unit 26 determines whether there has been an input to the proximity sensor 56c.

Here, when the proximity sensor 56c (right proximity sensor 56c) of the housing unit 42R is tapped or pressed long, or when the proximity sensor 56c (left proximity sensor 56c) of the housing unit 42L is tapped or pressed long, the information regarding this is transmitted from the headphone 3 to the imaging apparatus 2.

Then, in step S12, the camera control unit 26 determines whether there is any input to the proximity sensor 56c on the basis of the transmitted information.

As a result, in a case where there is an input to the proximity sensor 56c (Yes in step S12), the processing proceeds to step S6. In step S6, the operation control unit 62 controls the operation of the imaging apparatus 2 on the basis of the input to the proximity sensor 56c.

For example, in a case where the right proximity sensor 56c is tapped, the operation control unit 62 controls the imaging apparatus 2 to zoom in. Furthermore, in a case where the left proximity sensor 56c is tapped, the operation control unit 62 controls the imaging apparatus 2 to zoom out. Furthermore, in a case where the right proximity sensor 56c is pressed long, the operation control unit 62 controls the imaging apparatus 2 to increase the ISO speed. Furthermore, in a case where the left proximity sensor 56c is pressed long, the operation control unit 62 controls the imaging apparatus 2 to decrease the ISO speed.

As described above, in a case where the gesture is input to the proximity sensor 56c, the operation control unit 62 controls the operation by giving priority to the gesture. With this arrangement, the operation can be controlled in a manner of reflecting the intention of the user more.

### 3. Second Embodiment

In a second embodiment, the operation of the imaging apparatus 2 is controlled on the basis of a combination of the headphone gesture information and the camera state information.

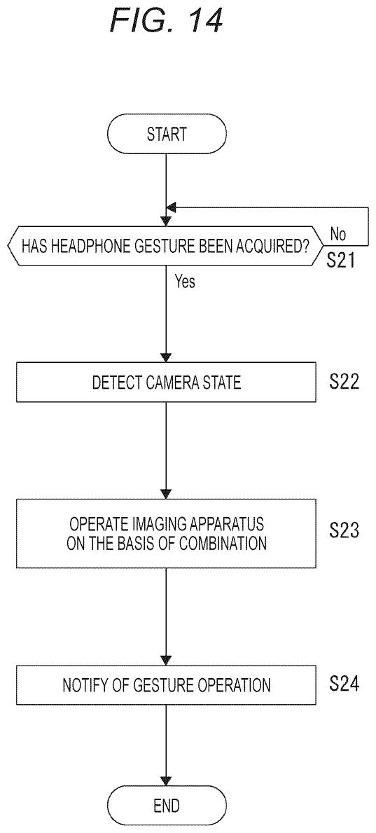

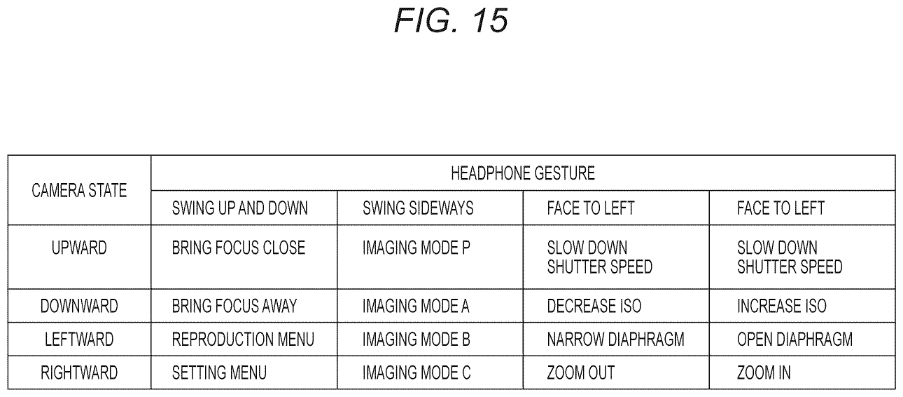

FIG. 14 is a diagram illustrating a flowchart of control processing in the second embodiment. FIG. 15 is a diagram illustrating an example of the operations of the imaging apparatus 2 with respect to a combination of the headphone gesture information and the camera state information.

As illustrated in FIG. 14, when the control processing is started, in step S21, the camera control unit 26 determines whether the headphone gesture information has been acquired from the headphone 3. Here, for example, the headphone gesture detection unit 71 detects the headphone gesture of any one of “swing up and down”, “swing sideways”, “face to the right”, and “face to the left”.

Upon receiving the headphone gesture information from the headphone 3, in step S22, the camera state detection unit 61 detects the camera state on the basis of the acceleration detected by the acceleration sensor 32a and the angular velocity detected by the gyro sensor 32b. Here, the camera state detection unit 61 detects the state change in, for example, “upward”, “downward”, “rightward”, or “leftward”.

In step S23, the operation control unit 62 controls the operation of the imaging apparatus 2 as illustrated in FIG. 15 on the basis of a combination of the headphone gesture information and the camera state information. For example, in a case where the headphone gesture is “swing up and down” and the camera state is “upward”, the operation control unit 62 performs control to bring the focus close. Furthermore, in a case where the headphone gesture is “swing sideways” and the camera state is “upward”, the operation control unit 62 performs control to change an imaging mode to P.

Note that the imaging mode P is a mode for automatically setting the exposure (shutter speed, diaphragm value). Furthermore, an imaging mode A is a mode in which the diaphragm value is preferentially set and the shutter speed is automatically adjusted. Furthermore, an imaging mode S is a mode in which the shutter speed is preferentially set and the diaphragm value is automatically adjusted. Furthermore, an imaging mode M is a mode in which the diaphragm value and the shutter speed are manually adjusted.

As described above, by controlling the operation of the imaging apparatus 2 on the basis of the combination of the headphone gesture information and the camera state information, the number of operations that can be performed by the gesture operation can be increased as compared with a case where the operation of the imaging apparatus 2 is controlled on the basis of only one of the headphone gesture information and the camera state information. That is, a large number of operations can be controlled by the gesture operation.

### 4. Third Embodiment

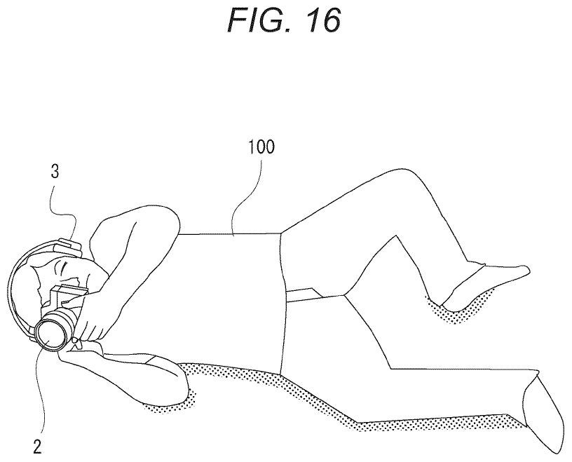

FIG. 16 is a diagram for explaining the orientation of the imaging apparatus 2 in a case where the user captures an image while lying on one's side. As illustrated in FIG. 16, at the time when the user 100 captures an image while lying on one's side, it is conceivable that the imaging apparatus 2 is also tilted to capture the image in accordance with the posture of the user 100.

In such a case, unless the orientation of the image (screen) displayed on the display unit 13 is changed, there is a possibility that the user 100 has difficulty in viewing the screen.

Therefore, in a third embodiment, the orientation of the image (screen) to be displayed on the display unit 13 is controlled on the basis of a combination of the headphone gesture information and the camera state information.

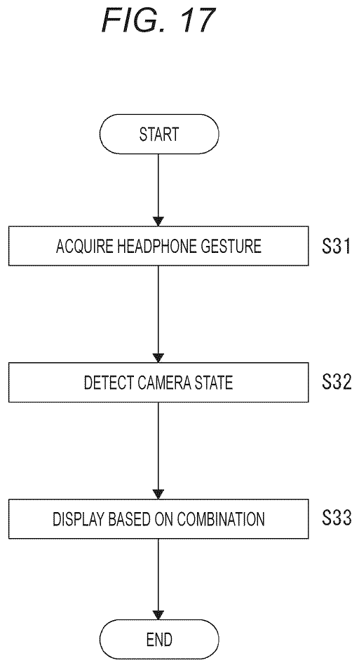

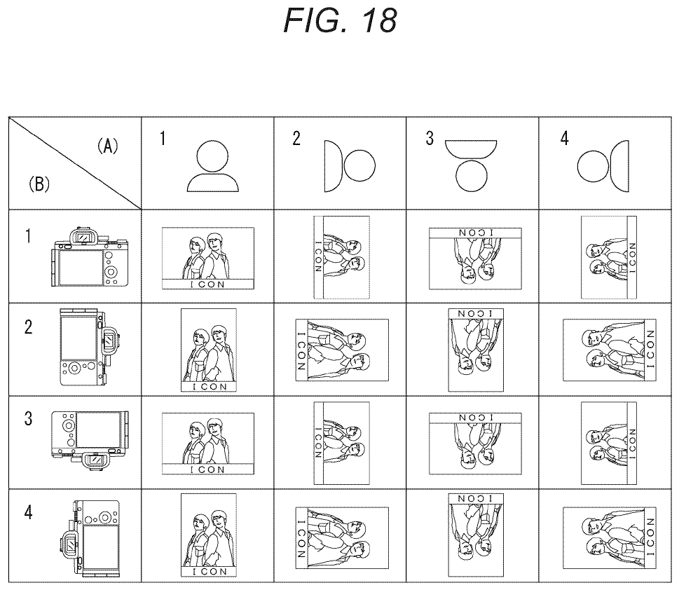

FIG. 17 is a diagram illustrating a flowchart of control processing in the second embodiment. FIG. 18 is a diagram illustrating an example of the orientations of the screen with respect to the headphone gesture and the camera state. Note that characters of “ICON” in FIG. 18 indicate the orientation of the icon displayed on the display unit 13.

As illustrated in FIG. 17, when the control processing is started, in step S31, the camera control unit 26 acquires the headphone gesture information from the headphone 3. Here, because it is sufficient to obtain the orientation (posture) of the user 100, the posture of the headphone 3 is acquired as the headphone gesture information.

Upon receiving the headphone gesture information from the headphone 3, in step S32, the camera state detection unit 61 detects the camera state on the basis of the acceleration detected by the acceleration sensor 32a and the angular velocity detected by the gyro sensor 32b. Here, the camera state detection unit 61 detects the posture of the imaging apparatus 2.

In step S33, the operation control unit 62 causes the display unit 13 to display the image in the orientation as illustrated in FIG. 18 on the basis of a combination of the headphone gesture information and the camera state information. In FIG. 18, (A) illustrates the orientation of the user 100 based on the headphone gesture information, and (B) illustrates the orientation of the imaging apparatus 2 based on the camera state.

For example, 1 of (A) in FIG. 18 indicates that the headphone 3 is facing the front and the user 100 is facing the front. Furthermore, 2 of (A) in FIG. 18 indicates that the headphone 3 is tilted to the right by 90° and the user 100 is facing sideways on the right. Furthermore, 3 of (A) in FIG. 18 indicates that the headphone 3 is turned upside down and the user 100 is facing upside down. Furthermore, 4 of (A) in FIG. 18 indicates that the headphone 3 is tilted to the left by 90° and the user 100 is facing sideways on the left.

1 of (B) in FIG. 18 indicates that the imaging apparatus 2 is facing the front. Furthermore, 2 of (B) in FIG. 18 indicates that the imaging apparatus 2 is rotated to the right by 90°. 3 of (B) in FIG. 18 indicates that the imaging apparatus 2 is turned upside down. 4 of (B) in FIG. 18 indicates that the imaging apparatus 2 is rotated to the left by 90°.

Then, for example, in a case where the user faces the front (1 of (A)) and the imaging apparatus 2 is rotated to the right by 90° (2 of (B)), the operation control unit 62 performs control so that the image displayed on the display unit 13 is displayed to be vertically long and faces the front.

Furthermore, for example, in a case where the user is facing sideways on the right (2 of (A)) and the imaging apparatus 2 is rotated to the right by 90° (2 of (B)), the operation control unit 62 performs control so that the image displayed on the display unit 13 is displayed to be horizontally long and rotated to the right by 90°.

As described above, in an information processing system 1, by determining the orientation of the image to be displayed on the display unit 13 in accordance with the orientation of the imaging apparatus 2 and the orientation of the headphone 3, the image can be easily viewed.

### 5. Fourth Embodiment

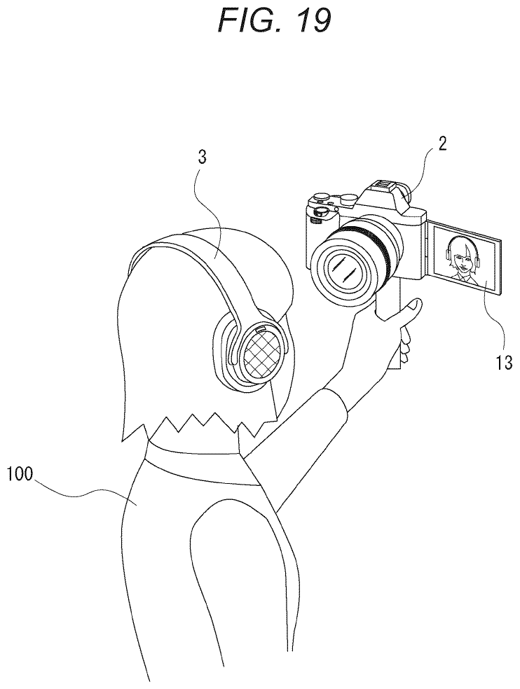

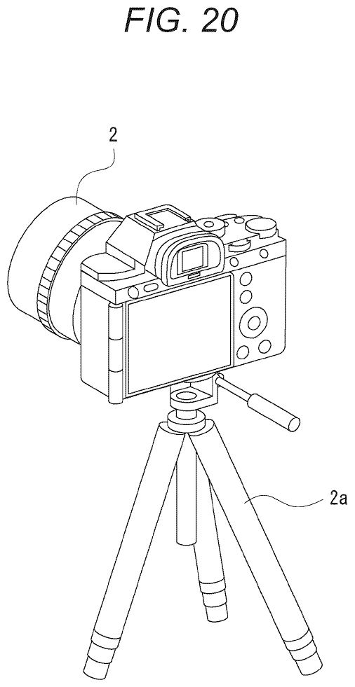

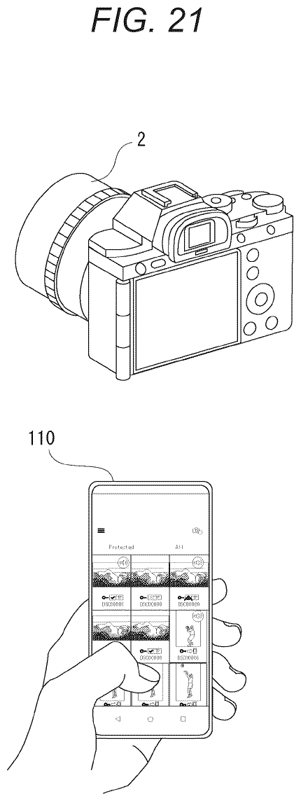

FIG. 19 is a diagram illustrating a state in which the user 100 is imaging oneself by the imaging apparatus 2. FIG. 20 is a diagram illustrating a state in which an image is being captured by the imaging apparatus 2 by using a tripod 2a. FIG. 21 is a diagram illustrating a state in which a mobile terminal apparatus 110 is wirelessly connected to the imaging apparatus 2.

Here, in some cases, the imaging apparatus 2 is used not only in a case where the user 100 captures an image of a subject from the display unit 13 or EVF 14 side, but, for example, also in a case where the user is taking a so-called selfie of capturing an image of the user 100 oneself is performed as illustrated in FIG. 19.

Furthermore, in some cases, the imaging apparatus 2 is not only held by the user 100, but also used in a state of being supported by the tripod 2a as illustrated in FIG. 20.

Moreover, as illustrated in FIG. 21, in some cases, the imaging apparatus 2 is wirelessly connected to the mobile terminal apparatus 110 such as a smartphone via the communication unit 25, and controls the operation of the imaging apparatus 2 on the basis of the operation on the mobile terminal apparatus 110.

A fourth embodiment is an embodiment for controlling the operation based on the headphone gesture information and the camera state information in such cases.

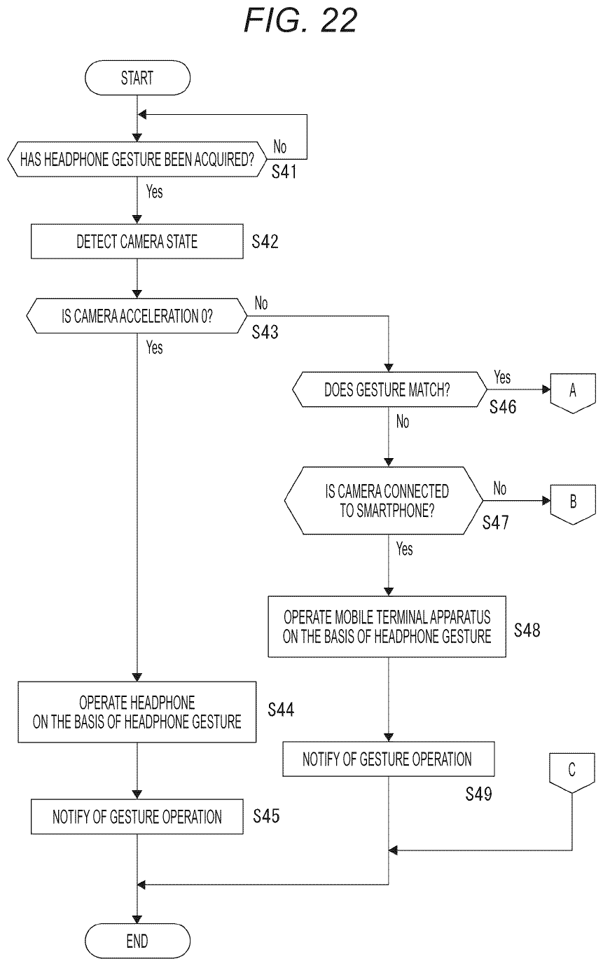

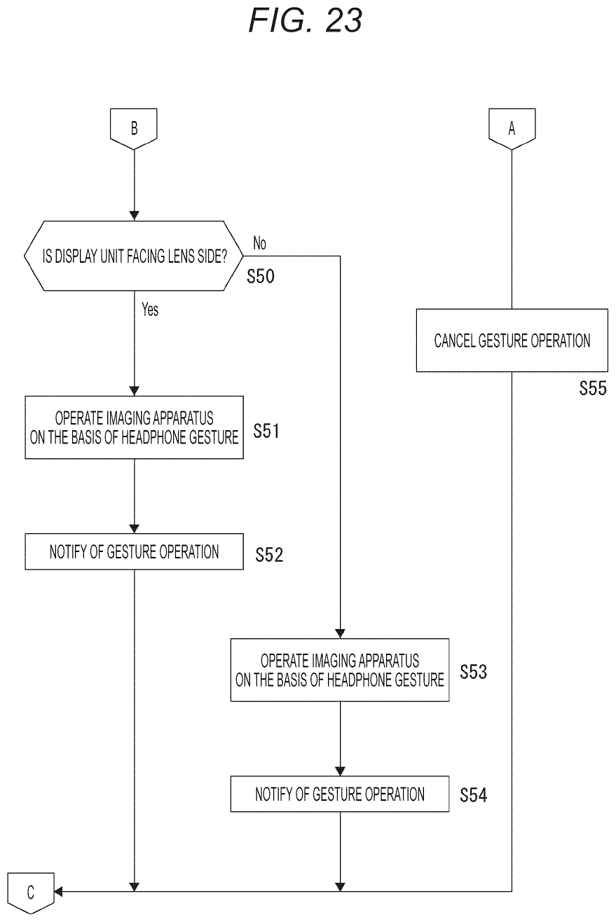

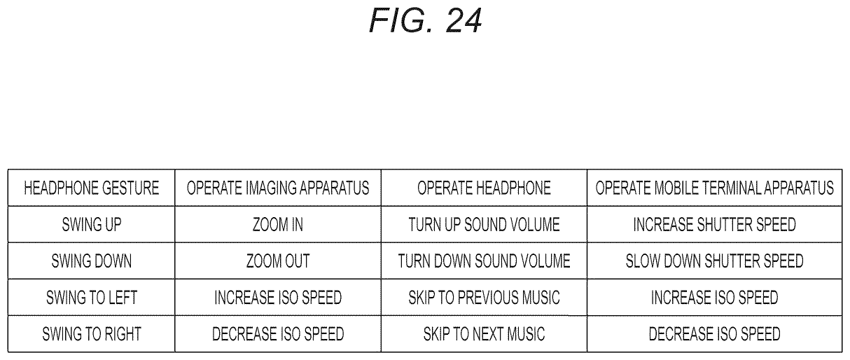

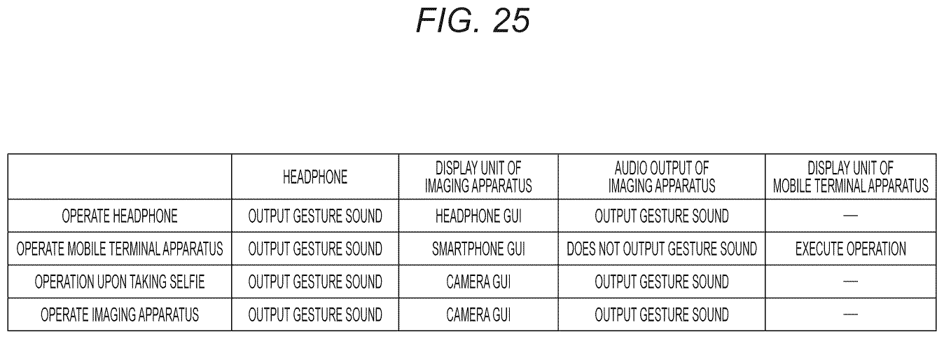

FIGS. 22 and 23 are diagrams each illustrating a flowchart of control processing in the fourth embodiment. FIG. 24 is a diagram illustrating an example of operations of the imaging apparatus 2, the headphone 3, and the mobile terminal apparatus 110 based on the headphone gesture. FIG. 25 is a diagram illustrating an example of notification made with respect to the headphone gesture information.

As illustrated in FIG. 22, when the control processing is started, in step S41, the camera control unit 26 determines whether the headphone gesture information has been acquired from the headphone 3.

Upon acquiring the information regarding the headphone gesture from the headphone 3, (Yes in step S41), in step S42, the camera state detection unit 61 detects the camera state on the basis of the acceleration detected by the acceleration sensor 32a and the angular velocity detected by the gyro sensor 32b.

In step S43, the operation control unit 62 determines whether the acceleration detected by the acceleration sensor 32a is 0. Here, it is determined whether or not the imaging apparatus 2 is held by the tripod 2a on the basis of whether or not the acceleration of the imaging apparatus 2 is 0, that is, whether or not the imaging apparatus 2 is moving.

In a case where the acceleration is 0 (Yes in step S43), that is, in a case where the imaging apparatus 2 is supported by the tripod 2a, in step S44, the operation control unit 62 controls the operation of the headphone 3 on the basis of the headphone gesture information.

Here, as illustrated in FIG. 24, similarly to the first embodiment, for example, in a case where the headphone gesture is “swing up”, the operation control unit 62 gives instruction to the headphone 3 to turn the sound volume up in the headphone 3. In the headphone 3, the operation control unit 72 performs control to turn up the sound volume.

In step S45, the notification control unit 63 notifies of the operation based on the headphone gesture information performed in step S44.

As illustrated in FIG. 25, in a case where the operation of the headphone 3 is controlled on the basis of the headphone gesture information, the notification control unit 63 instructs the headphone 3 to output, from the audio output unit 53, a gesture sound notifying that the headphone 3 has been operated on the basis of the headphone gesture information. With this arrangement, in the headphone 3, the notification control unit 73 causes the audio output unit 53 to output a gesture sound notifying that the headphone 3 has been operated on the basis of the headphone gesture information.

Furthermore, the notification control unit 63 causes the display unit 13 to display the headphone GUI 82 notifying that the headphone 3 has been operated on the basis of the headphone gesture information as illustrated in FIG. 11.

Moreover, the notification control unit 63 causes the audio output unit 31 to output a gesture sound notifying that the headphone 3 has been operated on the basis of the headphone gesture information.

On the other hand, in a case where the acceleration is not 0 (No in step S43), that is, in a case where at least the imaging apparatus 2 is not supported by the tripod 2a, in step S46, the operation control unit 62 determines whether the camera state matches the headphone gesture.

Then, in a case where the camera state does not match the headphone gesture (No in step S46), in step S47, the operation control unit 62 determines whether the imaging apparatus 2 is connected to the mobile terminal apparatus 110. Then, in a case where the imaging apparatus 2 is connected to the mobile terminal apparatus 110 (Yes in step S47), in step S48, the operation control unit 62 controls the operation of the mobile terminal apparatus 110 on the basis of the headphone gesture information.

Here, as illustrated in FIG. 24, in a case where the headphone gesture is “swing up”, the operation control unit 62 controls the operation of the mobile terminal apparatus 110 to increase the shutter speed. Furthermore, in a case where the headphone gesture is “swing down”, the operation control unit 62 controls the operation of the mobile terminal apparatus 110 to slow down the shutter speed. Furthermore, in a case where the headphone gesture is “swing to the left”, the operation control unit 62 controls the operation of the mobile terminal apparatus 110 to increase the ISO speed. Furthermore, in a case where the headphone gesture is “swing to the right”, the operation control unit 62 controls the operation of the mobile terminal apparatus 110 to decrease the ISO speed.

In step S49, the notification control unit 63 notifies of the operation based on the headphone gesture information performed in step S48.

As illustrated in FIG. 25, in a case where the operation of the mobile terminal apparatus 110 is controlled on the basis of the headphone gesture information, the notification control unit 63 instructs the headphone 3 to output, from the audio output unit 53, a gesture sound notifying that the mobile terminal apparatus 110 has been operated on the basis of the headphone gesture information.

Furthermore, the notification control unit 63 causes the display unit 13 to display a smartphone GUI notifying that the mobile terminal apparatus 110 has been operated on the basis of the headphone gesture information.

Note that, in the smartphone GUI, similarly to the camera GUI 81 and the headphone GUI 82, a smartphone icon and an operation control comment indicating that the mobile terminal apparatus 110 has been operated on the basis of the headphone gesture are displayed at the lower part.

Moreover, the notification control unit 63 causes the audio output unit 31 to output a gesture sound notifying that the mobile terminal apparatus 110 has been operated on the basis of the headphone gesture information.

Furthermore, the operation control unit 62 gives instruction to the mobile terminal apparatus 110 to cause a display unit of the mobile terminal apparatus 110 to display the content of the operation performed on the mobile terminal apparatus 110 on the basis of the headphone gesture information. With this arrangement, in the mobile terminal apparatus 110, the content of the operation performed on the mobile terminal apparatus 110 on the basis of the headphone gesture is displayed on the display unit.

On the other hand, in a case where the imaging apparatus 2 is not connected to the mobile terminal apparatus 110 (No in step S47), as illustrated in FIG. 23, the operation control unit 62 determines whether the display unit 13 of the imaging apparatus 2 is facing the lens barrel 12 side.

Here, as described above, in the imaging apparatus 2, the display unit 13 is rotatable with respect to the camera housing 11. Then, the sensor unit 32 of the imaging apparatus 2 is provided with a not-illustrated magnetic sensor that detects the rotation of the display unit 13. The operation control unit 62 determines whether the display unit 13 is facing the lens barrel 12 side on the basis of the detection result of the magnetic sensor.

Then, in a case where the display unit 13 is facing the lens barrel 12 side (Yes in step S50), that is, in a case where the user 100 is taking a selfie, in step S51, the operation control unit 62 controls the operation of the imaging apparatus 2 on the basis of the headphone gesture information.

Here, as illustrated in FIG. 24, similarly to the first embodiment, in a case where the headphone gesture is, for example, “swing up”, the operation control unit 62 controls the imaging apparatus 2 to zoom in.

In step S52, the notification control unit 63 notifies of the operation based on the headphone gesture information performed in step S51.

As illustrated in FIG. 25, in a case where the operation of the imaging apparatus 2 is controlled on the basis of the headphone gesture information, the notification control unit 63 instructs the headphone 3 to output, from the audio output unit 53, a gesture sound notifying that the imaging apparatus 2 has been operated on the basis of the headphone gesture information. With this arrangement, in the headphone 3, the notification control unit 73 causes the audio output unit 53 to output a gesture sound notifying that the imaging apparatus 2 has been operated on the basis of the headphone gesture information.

Furthermore, the notification control unit 63 causes the display unit 13 to display the camera GUI 81 notifying that the imaging apparatus 2 has been operated on the basis of the headphone gesture information as illustrated in FIG. 10.

However, in a case where the operation of the imaging apparatus 2 is controlled on the basis of the headphone gesture information, the notification control unit 63 causes the audio output unit 31 not to output the gesture sound notifying that the imaging apparatus 2 has been operated on the basis of the headphone gesture. This is to prevent the gesture sound from being collected when the gesture sound is output during taking a selfie.

On the other hand, in a case where the display unit 13 is not facing the lens barrel 12 side (No in step S50), that is, in a case where the user 100 is not taking a selfie, in step S53, the operation control unit 62 controls the operation of the imaging apparatus 2 on the basis of the headphone gesture information. Note that, because the control similar to that in step S51 is performed in step S53, the description thereof will be omitted.

In step S54, the notification control unit 63 notifies of the operation based on the headphone gesture information performed in step S52.

As illustrated in FIG. 25, in a case where the operation of the imaging apparatus 2 is controlled on the basis of the headphone gesture information, the notification control unit 63 instructs the headphone 3 to output, from the audio output unit 53, a gesture sound notifying that the imaging apparatus 2 has been operated on the basis of the headphone gesture information. With this arrangement, in the headphone 3, the notification control unit 73 causes the audio output unit 53 to output a gesture sound notifying that the imaging apparatus 2 has been operated on the basis of the headphone gesture information.

Furthermore, the notification control unit 63 causes the display unit 13 to display the camera GUI 81 notifying that the imaging apparatus 2 has been operated on the basis of the headphone gesture information as illustrated in FIG. 10.

Moreover, the notification control unit 63 causes the audio output unit 31 to output a gesture sound notifying that the imaging apparatus 2 has been operated on the basis of the headphone gesture information.

On the other hand, in a case where the camera state matches the headphone gesture (Yes in step S46), that is, in a case where the user 100 is moving while looking into the EVF 14 of the imaging apparatus 2, in step S55, the operation control unit 62 cancels the gesture operation. In this case, the operation control unit 62 determines that the user 100 is not making a gesture but the user 100 is only moving while looking into the EVF 14 of the imaging apparatus 2, and performs the control not to perform the gesture operation based on the headphone gesture information.

Note that, in a case where it is determined in step S46 that the camera state does not match the headphone gesture, the operation based on the headphone gesture information is canceled. Therefore, here, it can be said that the operation control unit 62 determines whether or not to execute the operation on the headphone 3 based on the headphone gesture information on the basis of the camera state information.

### 6. Modifications

Note that the embodiments are not limited to the specific examples described above and can adopt various configurations as modifications.

For example, in the embodiments described above, the headphone 3 is used as the head-mounted device that detects the state (movement, posture) of the head of the user 100. However, the head-mounted device may be any device that is mounted on the head of user 100, such as an earphone or a head-mounted display.

Furthermore, in the embodiments described above, in a case where the music is being reproduced by the headphone 3, the operation of the headphone 3 may be controlled on the basis of the headphone gesture.

Furthermore, in the embodiments described above, in a case where it is determined that the imaging apparatus 2 is capturing a bright scene, on the basis of, for example, a luminance value of the image, the determination threshold of the proximity sensor 56c may be lowered. With this arrangement, erroneous determination made by the proximity sensor 56c due to sunlight can be reduced.

Furthermore, in the first to fourth embodiments described above, the respective embodiments may be executed in combination, or all the embodiments may be executed while switching the embodiments to be executed.

Furthermore, in the embodiments described above, the camera control unit 26 of the imaging apparatus 2 functions as the operation control unit 62, but the headphone control unit 51 of the headphone 3 may function as the operation control unit 62. That is, the flowchart of each of the first embodiment to the fourth embodiment described above may be performed by the headphone control unit 51.

For example, in a case where the display unit 13 of the imaging apparatus 2 is not facing the lens side in the fourth embodiment (No in step S50), steps S5 to S9 in the first embodiment may be executed instead of steps S53 and S54.

Furthermore, in the embodiments described above, the imaging apparatus 2 has been described as an example of the information processing apparatus, but the headphone 3 may function as the information processing apparatus. Furthermore, a mobile terminal apparatus such as a smartphone connected to both the imaging apparatus 2 and the headphone 3 or a computer on a cloud may function as the information processing apparatus, instead of the imaging apparatus 2 or the headphone 3. In this case, it is only required for the information processing apparatus to transmit instruction information to the imaging apparatus 2, and the camera control unit 26 of the imaging apparatus 2 to perform various types of control on the basis of the instruction information.

Furthermore, the operation based on the headphone gesture information and the camera state information in the embodiments described above is an example, and operations other than the operation described above may be controlled on the basis of the headphone gesture information and the camera state information.

Furthermore, in the fourth embodiment described above, in a case where the display unit 13 of the imaging apparatus 2 is facing the lens side (Yes in step S50), that is, in a case where the user 100 is taking a selfie, the operation of the imaging apparatus 2 is controlled on the basis of the headphone gesture. However, in a case where the user 100 is taking a selfie, the imaging apparatus 2 is imaging the user 100 oneself, and there is a low possibility that the user 100 performs a gesture. Therefore, the operation based on the headphone gesture information may be canceled.

### 7. Summary

As described above in each example, the information processing apparatus (imaging apparatus 2) includes the control unit (camera control unit 26) that controls at least the operation of the imaging apparatus 2 on the basis of the gesture information indicating a gesture (headphone gesture) detected by the head-mounted device (headphone 3) mounted on the head of the user and the imaging apparatus state information (camera state information) indicating a state of the imaging apparatus 2.

With this arrangement, at the time when at least the operation of the imaging apparatus 2 is controlled by the headphone gesture, the headphone gesture can be canceled in accordance with the camera state when the imaging apparatus 2 and the headphone 3 perform substantially the same movement.

Therefore, the imaging apparatus 2 can accurately control the operation on the basis of a state of the head of the user.

In a case where the gesture matches the movement of the imaging apparatus 2, the control unit cancels the operation based on the gesture information.

With this arrangement, when the imaging apparatus 2 and the headphone 3 are performing substantially the same movement, it can be determined that the head of the user 100 is moving together with the imaging apparatus 2 and is not making a gesture. Therefore, in the imaging apparatus 2, it is possible to reduce an erroneous operation on the basis of the headphone gesture information.

In a case where the gesture does not match the movement of the imaging apparatus 2, the control unit controls the operations of the imaging apparatus 2 and the head-mounted device on the basis of the gesture information.

With this arrangement, when the imaging apparatus 2 and the headphone 3 are not performing substantially the same movement, it can be determined that the user is intentionally making a gesture. Therefore, in the imaging apparatus 2, it is possible to reduce an erroneous operation on the basis of the headphone gesture information.

In a case where the imaging apparatus 2 is capturing a moving image, the control unit controls the operation of the imaging apparatus 2 on the basis of the gesture information.

With this arrangement, at the time when the moving image is being captured by the imaging apparatus 2 and it is desired to prevent camera shake, the operation of the imaging apparatus 2 can be controlled on the basis of the headphone gesture information, so that the camera shake can be reduced in the imaging apparatus 2.

In a case where the imaging apparatus 2 is not capturing a moving image, the control unit controls the operation of the head-mounted device on the basis of the gesture information.

With this arrangement, it is determined that the user 100 has performed the headphone gesture simply to operate the headphone 3 because the moving image is not being captured by the imaging apparatus 2, and the operation of the headphone 3 can be controlled on the basis of the headphone gesture information.

The control unit performs control to notify the user of information indicating control of the operation based on the gesture information.

With this arrangement, in the imaging apparatus 2, it can be easily grasped which apparatus has been operated in what manner by the headphone gesture.

The control unit causes the display unit 13 of the imaging apparatus 2 to display information indicating which of the operation of the head-mounted device or the imaging apparatus 2 has been controlled.

With this arrangement, in the imaging apparatus 2, it can easily grasped through the screen of the display unit 13 which apparatus has been operated and how by the headphone gesture.

The control unit causes the display unit 13 to display information indicating control of the operation based on the gesture information in a display mode different between a case where the operation of the head-mounted device is controlled on the basis of the gesture information and a case where the operation of the imaging apparatus 2 is controlled on the basis of the gesture information.

With this arrangement, in the imaging apparatus 2, it can be more easily grasped, through the screen of the display unit 13, which apparatus has been operated and how by the headphone gesture.

The control unit causes the display unit 13 to display an icon (camera icon 81a, headphone icon 82a) imitating the head-mounted device or the imaging apparatus 2 that controls the operation on the basis of the gesture information.

With this arrangement, the imaging apparatus 2 can more easily grasp the operation control target by displaying the icon on the display unit 13.

The control unit causes the display unit 13 to display information in a more highlighted display mode in a case where the operation of the imaging apparatus 2 is controlled on the basis of the gesture information than in a case where the operation of the head-mounted device is controlled on the basis of the gesture information.

For example, when it is desired to control the operation of the imaging apparatus 2 on the basis of the headphone gesture information, the characters of the operation control comment 81b are displayed in a larger size and a brighter color than the characters of the operation control comment 82b at the time when the headphone 3 is operated and controlled on the basis of the headphone gesture.

With this arrangement, the imaging apparatus 2 can more easily grasp the operation control target. Furthermore, the display can be prevented from interfering with imaging at the time when the operation of the headphone 3 is controlled.

In a case where the operation of the head-mounted device is controlled on the basis of the gesture information, the control unit causes the audio output unit 31 of the imaging apparatus 2 to output a notification sound (gesture sound), and causes the audio output unit 31 of the imaging apparatus 2 not to output the notification sound in a case where the operation of the imaging apparatus 2 is controlled on the basis of the gesture information.

With this arrangement, the notification sound can be prevented from being collected in a case where the notification sound is not desired to be collected by the audio input unit 29 of the imaging apparatus 2, the sound being generated by, for example, the operation or the like at the time when the moving image is being captured by the imaging apparatus 2.

In a case where the moving image is being captured by the imaging apparatus 2, the control unit causes the audio output unit 31 of the imaging apparatus 2 not to output a notification sound.

With this arrangement, the notification sound can be prevented from being collected by the audio input unit 29 at the time when, for example, the moving image is being captured by the imaging apparatus 2.

In a case where the proximity sensor 32c provided in the imaging apparatus 2 detects the user 100, the control unit cancels the operation based on the gesture information.

With this arrangement, in a case where the proximity sensor 32c is detecting the user 100, that is, in a case where the user 100 is looking into the EVF 14, the operation based on the headphone gesture not intended by the user 100 can be reduced.

In a case where the movement (acceleration) of the imaging apparatus 2 is not detected, the control unit controls the operation of the head-mounted device on the basis of the gesture information.

With this arrangement, at the time when the imaging apparatus 2 is supported by the tripod 2a, the operation of the headphone 3 can be controlled on the basis of the headphone gesture information.

In a case where the imaging apparatus 2 is connected to the mobile terminal apparatus 110, the control unit controls the operation of the mobile terminal apparatus 110 on the basis of the gesture information.

With this arrangement, the mobile terminal apparatus 110 connected to the imaging apparatus 2 can be operated by the headphone gesture, and further improvement in usability can be provided to the user 100.

The control unit controls the operation of the imaging apparatus 2 on the basis of a combination of the gesture information and the imaging apparatus state information.

With this arrangement, the imaging apparatus 2 can control a large number of operations by gestures by a combination of the headphone gesture information and the camera state information.

The control unit determines the orientation of the image displayed on the display unit of the imaging apparatus 2 on the basis of the orientation of the head-mounted device indicated by the gesture information and the orientation of the imaging apparatus 2 indicated by the imaging apparatus state information.

With this arrangement, even when the posture of the user 100 is turned sideways or upside down, the image can be displayed in the orientation that is easy for the user 100 to see.

In a case where the display unit 13 of the imaging apparatus 2 is facing the subject side, the control unit cancels the operation based on the gesture information.

With this arrangement, when a so-called selfie is being taken, the headphone gesture is not often performed because the subject is the user 100 oneself. Therefore, the operation based on the headphone gesture information can be prevented from being performed.

Furthermore, in the information processing method, at least the operation of the imaging apparatus 2 is controlled on the basis of the gesture information indicating the gesture detected by the head-mounted device (headphone 3) mounted on the head of the user and the imaging apparatus state information indicating the state of the imaging apparatus 2.

Furthermore, the information processing apparatus (imaging apparatus 2) includes the control unit (camera control unit 26) that determines, on the basis of the state of the imaging apparatus 2, whether or not to perform the operation on the head-mounted device (headphone 3) mounted on the head of the user, the operation being based on the gesture detected by the head-mounted device.

With this arrangement, at the time when the operation of the headphone 3 is controlled by the headphone gesture, whether or not to execute the headphone gesture can be determined in accordance with the camera state when the imaging apparatus 2 and the headphone 3 perform substantially the same movement.

Note that the effects described in the present description are merely examples and are not limited, and furthermore, other effects may be provided.

Furthermore, the above-described examples can be combined in any way, and the above-described various functions and effects can be obtained even in a case where various combinations are used.

### 8. Present Technology

Note that the present technology can also adopt the following configurations.

### 1

An information processing apparatus including
a control unit that controls at least an operation of an imaging apparatus on the basis of gesture information indicating a gesture detected by a head-mounted device mounted on the head of a user and imaging apparatus state information indicating a state of the imaging apparatus.

### 2

The information processing apparatus according to (1), in which,
in a case where the gesture matches a movement of the imaging apparatus, the control unit cancels an operation based on the gesture information.

### 3

The information processing apparatus according to (1) or (2), in which,
in a case where the gesture does not match a movement of the imaging apparatus, the control unit controls operations of the imaging apparatus and the head-mounted device on the basis of the gesture information.

### 4

The information processing apparatus according to any one of (1) to (3), in which,
in a case where a moving image is being captured by the imaging apparatus, the control unit controls an operation of the imaging apparatus on the basis of the gesture information.

### 5

The information processing apparatus according to any one of (1) to (4), in which,
in a case where a moving image is not being captured by the imaging apparatus, the control unit controls an operation of the head-mounted device on the basis of the gesture information.

### 6

The information processing apparatus according to any one of (1) to (5), in which
the control unit performs control to notify the user of information indicating control of an operation based on the gesture information.

### 7

The information processing apparatus according to (6), in which
the control unit causes a display unit of the imaging apparatus to display information indicating which of an operation of the head-mounted device or the imaging apparatus has been controlled.

### 8

The information processing apparatus according to (6) or (7), in which
the control unit causes a display unit of the imaging apparatus to display information indicating control of an operation based on the gesture information in a display mode different between a case where an operation of the head-mounted device is controlled on the basis of the gesture information and a case where an operation of the imaging apparatus is controlled on the basis of the gesture information.

### 9

The information processing apparatus according to (8), in which
the control unit causes the display unit to display an icon imitating the head-mounted device or the imaging apparatus that controls an operation on the basis of the gesture information.

### 10

The information processing apparatus according to (8) or (9), in which
the control unit causes the display unit of the imaging apparatus to display information in a more highlighted display mode in a case where an operation of the imaging apparatus is controlled on the basis of the gesture information than in a case where an operation of the head-mounted device is controlled on the basis of the gesture information.

### 11

The information processing apparatus according to any one of (6) to (10), in which,
in a case where an operation of the head-mounted device is controlled on the basis of the gesture information, the control unit causes an audio output unit of the imaging apparatus to output a notification sound, and,
in a case where an operation of the imaging apparatus is controlled on the basis of the gesture information, the control unit causes the audio output unit of the imaging apparatus not to output the notification sound.

### 12

The information processing apparatus according to any one of (6) to (11), in which,
in a case where a moving image is being captured by the imaging apparatus, the control unit causes an audio output unit of the imaging apparatus not to output a notification sound.

### 13

The information processing apparatus according to any one of (1) to (12), in which,
in a case where a proximity sensor provided in the imaging apparatus detects a user, the control unit cancels an operation based on the gesture information.

### 14

The information processing apparatus according to any one of (1) to (13), in which,
in a case where a movement of the imaging apparatus is not detected, the control unit controls an operation of the head-mounted device on the basis of the gesture information.

### 15

The information processing apparatus according to any one of (1) to (14), in which,
in a case where the imaging apparatus is connected to a mobile terminal apparatus, the control unit controls an operation of the mobile terminal apparatus on the basis of the gesture information.

### 16

The information processing apparatus according to any one of (1) to (15), in which
the control unit controls an operation of the imaging apparatus on the basis of a combination of the gesture information and the imaging apparatus state information.

### 17

The information processing apparatus according to any one of (1) to (16), in which
the control unit determines an orientation of an image displayed on a display unit of the imaging apparatus on the basis of an orientation of the head-mounted device indicated by the gesture information and an orientation of the imaging apparatus indicated by the imaging apparatus state information.

(18) The information processing apparatus according to any one of (1) to (17), in which,
in a case where a display unit of the imaging apparatus is facing a subject side, the control unit cancels an operation based on the gesture information.

### 19

An information processing method including
controlling at least an operation of an imaging apparatus on the basis of gesture information indicating a gesture detected by a head-mounted device mounted on the head of a user and imaging apparatus state information indicating a state of the imaging apparatus.

### 20

An information processing apparatus including
a control unit that determines, on the basis of a state of an imaging apparatus, whether or not to perform an operation on a head-mounted device mounted on a head of a user, the operation being based on a gesture detected by the head-mounted device.

### REFERENCE SIGNS LIST

1 Information processing system
2 Imaging apparatus (Information processing apparatus)
3 Headphone
26 Camera control unit
51 Headphone control unit
61 Camera state detection unit
62 Operation control unit
63 Notification control unit
71 Headphone gesture detection unit
72 Operation control unit
73 Notification control unit

1. An information processing apparatus comprising
a control unit that controls at least an operation of an imaging apparatus on a basis of gesture information indicating a gesture detected by a head-mounted device mounted on a head of a user and imaging apparatus state information indicating a state of the imaging apparatus.

2. The information processing apparatus according to claim 1, wherein,
in a case where the gesture matches a movement of the imaging apparatus, the control unit cancels an operation based on the gesture information.

3. The information processing apparatus according to claim 1, wherein,
in a case where the gesture does not match a movement of the imaging apparatus, the control unit controls operations of the imaging apparatus and the head-mounted device on a basis of the gesture information.

4. The information processing apparatus according to claim 1, wherein,
in a case where a moving image is being captured by the imaging apparatus, the control unit controls an operation of the imaging apparatus on a basis of the gesture information.

5. The information processing apparatus according to claim 1, wherein,
in a case where a moving image is not being captured by the imaging apparatus, the control unit controls an operation of the head-mounted device on a basis of the gesture information.

6. The information processing apparatus according to claim 1, wherein
the control unit performs control to notify the user of information indicating control of an operation based on the gesture information.

7. The information processing apparatus according to claim 6, wherein
the control unit causes a display unit of the imaging apparatus to display information indicating which of an operation of the head-mounted device or the imaging apparatus has been controlled.

8. The information processing apparatus according to claim 6, wherein
the control unit causes a display unit of the imaging apparatus to display information indicating control of an operation based on the gesture information in a display mode different between a case where an operation of the head-mounted device is controlled on a basis of the gesture information and a case where an operation of the imaging apparatus is controlled on a basis of the gesture information.

9. The information processing apparatus according to claim 8, wherein
the control unit causes the display unit to display an icon imitating the head-mounted device or the imaging apparatus that controls an operation on a basis of the gesture information.

10. The information processing apparatus according to claim 8, wherein
the control unit causes the display unit of the imaging apparatus to display information in a more highlighted display mode in a case where an operation of the imaging apparatus is controlled on a basis of the gesture information than in a case where an operation of the head-mounted device is controlled on a basis of the gesture information.

11. The information processing apparatus according to claim 6, wherein,
in a case where an operation of the head-mounted device is controlled on a basis of the gesture information, the control unit causes an audio output unit of the imaging apparatus to output a notification sound, and,
in a case where an operation of the imaging apparatus is controlled on a basis of the gesture information, the control unit causes the audio output unit of the imaging apparatus not to output the notification sound.

12. The information processing apparatus according to claim 6, wherein,
in a case where a moving image is being captured by the imaging apparatus, the control unit causes an audio output unit of the imaging apparatus not to output a notification sound.

13. The information processing apparatus according to claim 1, wherein,
in a case where a proximity sensor provided in the imaging apparatus detects a user, the control unit cancels an operation based on the gesture information.

14. The information processing apparatus according to claim 1, wherein,
in a case where a movement of the imaging apparatus is not detected, the control unit controls an operation of the head-mounted device on a basis of the gesture information.

15. The information processing apparatus according to claim 1, wherein,
in a case where the imaging apparatus is connected to a mobile terminal apparatus, the control unit controls an operation of the mobile terminal apparatus on a basis of the gesture information.

16. The information processing apparatus according to claim 1, wherein
the control unit controls an operation of the imaging apparatus on a basis of a combination of the gesture information and the imaging apparatus state information.

17. The information processing apparatus according to claim 1, wherein
the control unit determines an orientation of an image displayed on a display unit of the imaging apparatus on a basis of an orientation of the head-mounted device indicated by the gesture information and an orientation of the imaging apparatus indicated by the imaging apparatus state information.

18. The information processing apparatus according to claim 1, wherein,
in a case where a display unit of the imaging apparatus is facing a subject side, the control unit cancels an operation based on the gesture information.

19. An information processing method comprising
controlling at least an operation of an imaging apparatus on a basis of gesture information indicating a gesture detected by a head-mounted device mounted on a head of a user and imaging apparatus state information indicating a state of the imaging apparatus.

20. An information processing apparatus comprising
a control unit that determines, on a basis of a state of an imaging apparatus, whether or not to perform an operation on a head-mounted device mounted on a head of a user, the operation being based on a gesture detected by the head-mounted device.
